(19) United States
(12) Patent Application Publication
(10) Pub. No.: US 2007/0174460 A1
(43) Pub. Date: Jul. 26, 2007

(54) Method and system for on demand weighted proportional distribution of enterprise allocations

(75) Inventors: Matthew J. Bangel, Poughkeepsie, NY (US); Gregory V. Feeney, Wappingers Falls, NY (US); William M. Houston, Essex Junction, VT (US); Robert G. Madsen, Pahoa, HI (US); James A. Martin JR., Endicott, NY (US)

Correspondence Address: Steven Fischman, Esq.;Scully, Scott, Murphy & Presser, 400 Garden City Plaza, Garden City, NY, 11530, US

(73) Assignee: International Business Machines Corporation, Armonk, NY (US)

(21) Appl. No.: 11/339,928

(22) Filed: Jan. 26, 2006

(51) Int. Cl. G06F 15/173

(52) U.S. Cl. 709/226

(57) ABSTRACT

Discloses are a method of and system for allocating resources in an enterprise. The method comprises the steps of identifying a number of areas of the enterprise that need resources, and determining an initial allocation of resources to each of said areas. The method comprises the further steps of establishing an algorithm to assign weights to said initial allocations, using said algorithm to determine weighted allocations of resources for each of said areas, and keeping said weighted allocations for a given time period. As resources become available during said defined time period, said available resources are assigned to said areas based on said weighted allocations.

### CROSS-REFERENCE TO RELATED APPLICATION

This application is related to copending application Ser. No. 10/040,844, for “Workstation Management Tool,” filed Jan. 7, 2002, the disclosure of which is hereby incorporated herein by reference in its entirety.

### BACKGROUND OF THE INVENTION

1. Field of the Invention

This invention generally relates to managing resources in an organization or business. More specifically, the invention relates to distribution of enterprise allocations in an organization or business.

2. Background Art

Within the information technology services industry, providing resources such as computer workstations and related equipment to the employees in a client business is an important service from a financial and customer satisfaction perspective. Employees typically will want the newest most powerful hardware in order to perform their tasks as easily and quickly as possible. These tend to be very expensive and rapidly depreciate in value. Company managers focus on controlling cost, albeit consistent with good productivity, and therefore limit spending on such hardware to what is the minimum needed for employees to get-their jobs done. A service provider attempts to use skills, experience, and tools to manage the total workstation requirements over a period of time to optimize the entire process.

One specific need is for a simple way to distribute inventory of computer machinery to separate business areas based on need, or a weighted amount of machines required. So when inventory of these machines was available, an organization could place the number of machines received in a field and have an automatic distribution of these machines to separate business areas based on the weighted allocations. Solutions to this problem tend to be manual distribution of inventory without an automated process. The biggest problem with this is that computer workstation inventory may not be available at the same time; an organization might receive additional machinery over the course of a year. So each time inventory is received, each business area must be given a select amount of assets by a system administrator manually.

### SUMMARY OF THE INVENTION

An object of this invention is to provide an improved distribution of enterprise allocations in an organization or business.

Another object of the present invention is to provide a weighted allocation to distribute equipment or other resources within an enterprise.

A further object of the invention is to enable an on-demand distribution of resources across an enterprise using a weighted allocation that is determined based on resources requested over a given time period.

These and other objectives are attained with a method of and system for allocating resources in an enterprise. The method comprises the steps of identifying a number of areas of the enterprise that need resources, and determining an initial allocation of resources to each of said areas. The method comprises the further steps of establishing an algorithm to assign weights to said initial allocations, using said algorithm to determine weighted allocations of resources for each of said areas, and keeping said weighted allocations for a given time period. As resources become available during said defined time period, said available resources are assigned to said areas based on said weighted allocations.

With the preferred embodiment of the invention, described in detail below, the weighted allocation is a specified number of machines required for a business area. When these numbers are compared against available inventory across all business areas, each business area can automatically be distributed the proportional amount of machines necessary to suit their business needs. After weighted allocations are specified, they always exist, and can always be modified. Therefore, as new machinery comes in, existing weighted allocations can still be used to provide the formula for inventory distribution. The manual work to decide upon these priorities in the beginning, up front, provides countless hours of saved manpower in future inventory distributions.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a flow chart showing a preferred method for performing the present invention.

FIG. 2 schematically illustrates a system for implementing this invention.

FIG. 3 shows a form that may be used in this invention.

FIG. 4 shows process steps in a workstation management in which the present invention may be used.

FIG. 5 illustrates a functional block diagram of the tasks performed at various steps in the workstation management shown in FIG. 4.

FIG. 6 shows elements of a tool for managing workstations.

FIG. 7 relates process steps and elements of a workstation management tool.

### DETAILED DESCRIPTION OF THE PREFERRED EMBODIMENTS

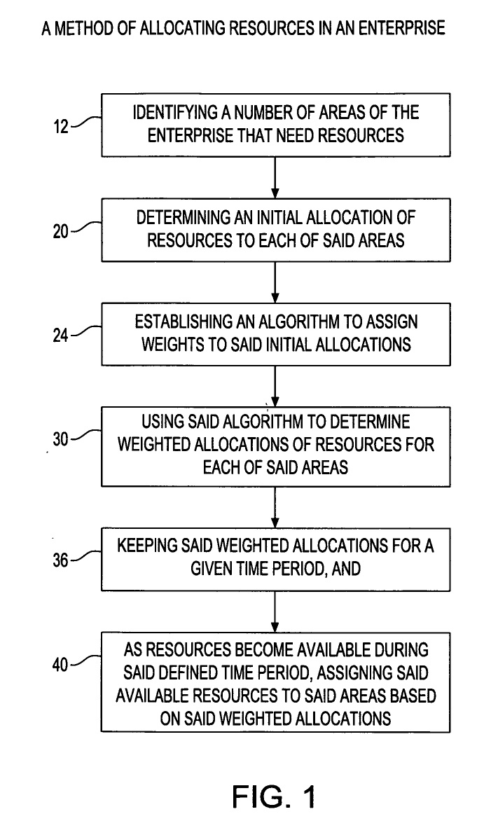

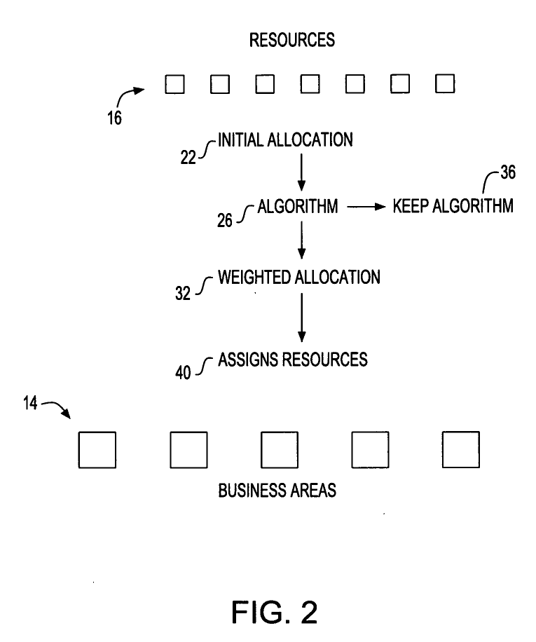

The present invention provides a method and apparatus for allocating resources in an enterprise. With reference to FIGS. 1 and 2, the preferred method comprises the stepl2 of identifying a number of areas 14 of the enterprise that need resources 16, and the step 20 of determining an initial allocation 22 of resources to each of said areas. The method comprises the further step 24 of establishing an algorithm 26 to assign weights to said initial allocations, and the step 30 of using said algorithm to determine weighted allocations 32 of resources for each of said areas. As represented at steps 36 and 40, the weighted allocations are kept for a given time period; and as resources become available during that defined time period, the available resources are assigned to said areas based on said weighted allocations.

The weighted allocations, for example, may be a specified number of machines required for a business area. When these numbers are compared against available inventory across all business areas, each business area can automatically be distributed the proportional amount of machines necessary to suit their business needs. After weighted allocations are specified, they always exist, and can always be modified. Therefore, as new machinery comes in, we can still use existing weighted allocations to provide the formula for inventory distribution. The manual work to decide upon these priorities in the beginning, up front, provides countless hours of saved manpower in future inventory distributions.

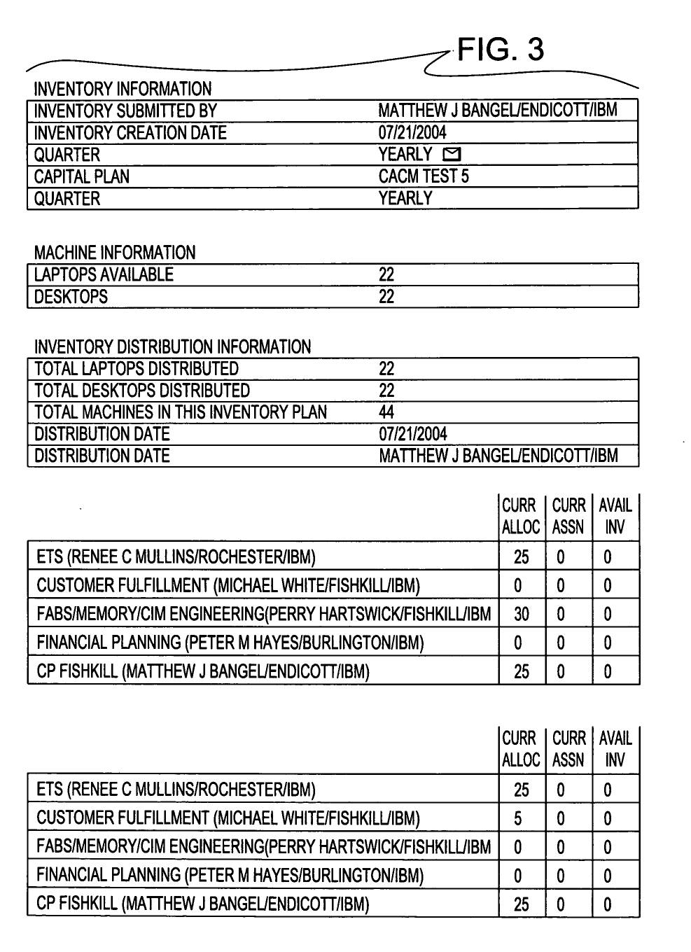

FIG. 3 illustrates a form that may be used in the implementation of the invention to distribute available inventory across an entire organization. More specifically, once the weighted allocations are established, a user will enter the necessary information about the organization to which the resources are being distributed, the amount of available inventory, and then simply hit a button on a computer screen to produce the proper distribution. The user is then allowed to make any manual changes to the distribution if required per business need. For example, the form of FIG. 3 shows a total amount of inventory distributed (between desktops and laptops), a current allocation (weighted allocation), and a weighted distribution of inventory for each business area. The action buttons that allow manipulation of the data are not shown in FIG. 3.

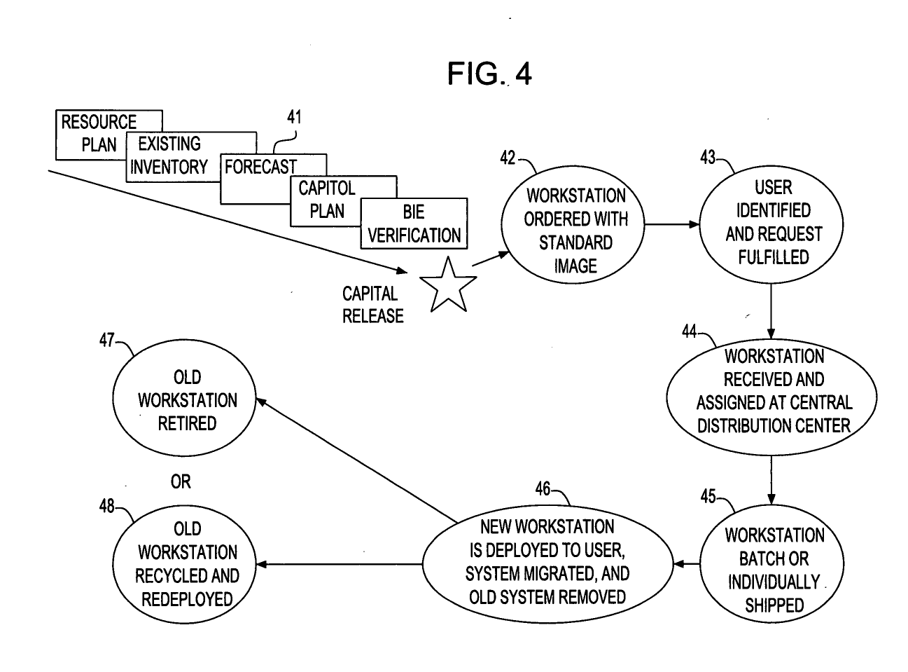

The present invention may be used in many different specific situations. For example, the invention may be used in a workstation management tool illustrated in FIGS. 4-6.

Preferably, this workstation management tool is implemented on a server computer system accessible by information technology service providing employees. However any type of computer system may be used including a plurality of processors of any type whether mainframe, personal computers, portables, laptops, or other. In step 41 of FIG. 4, a capital plan is developed. Inputs to the capital plan include a resource plan describing the number and type of client employees needing workstation service support. The resource plan typically covers a period of time such as one or several years broken down by quarter, month or some other period of time for which the client or service provider makes business decisions on capital releases. The resource plan may include new hires (for which a workstation will be needed at or shortly after the hiring date), departures, transfers, temporary workers, and supplemental employees as well as permanent employees assigned to various business units and locations within the client organization.

The capital plan of step 41 also includes inputs of an existing inventory of workstations which may include hardware type e.g. processor, display, printer, or scanner, the hardware age and book value. A standard offering configuration may be defined. An upgrade percentage may be specified for existing workstations. From the above inputs, a forecast of workstations and capital requirements is calculated for each period of time for capital releases typically quarterly. The forecast is submitted to a finance organization and to a business unit information executive (BIE) for approval. The BIE or a representative designated by the BIE may also allocate workstations to a particular group or to individual employees in a respective business unit.

Capital funds are therefore released as approved and in step 42 workstations are ordered. Workstations herein are taken to mean any hardware or software items provided to a client employee as part of an information technology service for the client. The workstations may be a complete system, a single element e.g. processor only, or a feature of an element such as additional memory or a larger hard drive or a new version of a software application. The workstation may be a desktop, laptop, portable, palm device, or any other type of information technology product. If a standard offering configuration is defined above, then workstations will be ordered configured with this standard offering (also referred to as a standard image) in step 42.

In step 43, workstations are received. The receipt may be at a central distribution center, receiving area, or any suitable location. At step 44, the workstations are allocated and distributed, using the method of the present invention. Generally, an initial allocation is determined, and then weighted allocations are determined. After the weighted allocations are determined, the workstations are distributed at step 45 on the basis of those weighted allocations.

When the workstation is a processor, applications unique to the business unit of the selected individual (BIE applications) are added to the workstation in step 46. The new hardware is also deployed, and installed in step 46 and the old hardware is removed.

The old workstation hardware is retired from service (disposed as unusable) in step 47 or else it is recycled and redeployed (cascaded to the next person who will receive it) in step 48. Records of all the above actions are kept using a customer account manager application, a workstation planning and deployment manager application, a client information manager application and an asset information manager application which interact and when taken together comprise an integrated lifecycle management tool for workstations as described below.

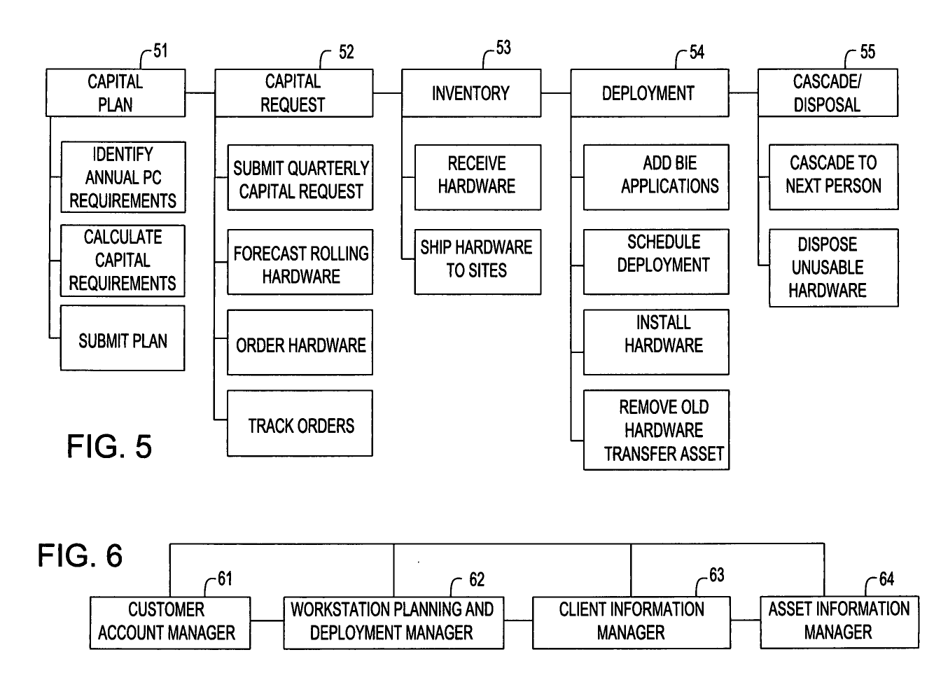

A functional block diagram showing tasks, which may be performed at various process steps, is illustrated in FIG. 5. Formation of capital plan 51 may include identifying workstation requirements. The workstations may be a personal computer (PC) and the identification may be made to cover any period of time, typically annually. The capital requirements to acquire workstations are then calculated and a capital plan presented to a finance organization for approval.

A capital request 52 is then periodically, e.g. quarterly, submitted for approval. The capital request may include a forecast of rolling hardware. A forecast of rolling hardware is taken to mean a forecast for a current period e.g. quarter and a forecast for a next sequential period e.g. next quarter. However, the approval is requested only for the current period. A subsequent approval will normally be requested at a later time for the next sequential period, however at that time a new forecast for the next sequential period which may be different than the original forecast above, will be provided. A forecast of the second next sequential period will also be provided at that time but the requested approval request will be for only the first sequential period. Upon approval, the hardware is ordered and tracked.

Ordered hardware is received and added to inventory 53, and the hardware is then allocated, using the above-described procedures of this invention. Once allocated, the hardware is shipped to the individuals located at various sites. Deployment 54 is scheduled. BIE applications are added as needed and the hardware is installed for the selected individuals. Old hardware is removed and appropriate asset transfer records are made.

A cascade/disposal process 55 determines whether the old workstation is usable by another individual and if so it is redeployed to the next scheduled person. If not usable, then arrangements are made and record changes made to dispose as unusable.

In FIG. 6 there is shown an integrated lifecycle management tool for workstations in accordance with the present invention. Customer account manager application 61 comprises software for defining financial relationships of owners of workstations. For example, the business unit or department to which an individual owner belongs may be defined. Which information technology representative handles that owner may also be defined. Which finance group or which BIE approves capital requests for that individual owner may be defined.

Customer account manager application 61 is coupled to workstation planning and deployment manager application 62. Capital plans for workstations are defined as described above using workstation planning and deployment manager application 62 which by necessity accesses the financial relationships defined in customer account manager application 31, or receives updates from customer account manager application 61.

Client information manager (CIM) 63 maintains information about owners of workstations such as the owner's name and location of the workstation. CIM is also adapted to accept entry of deployment information of workstations to owners. Both owner information and deployment information is shared with workstation planning and deployment manager 62 in order to facilitate formulation of capital plans.

Asset information manager application (AIM) 64 maintains detailed capital asset information for the workstations such as serial numbers and book values. AIM is also adapted to receive deployment updates on capital assets as they occur from CIM. AIM may also provide asset information updates to CIM. Other applications may also be used separately or in concert with elements 61, 62, 63, and 64 without departing from the present invention.

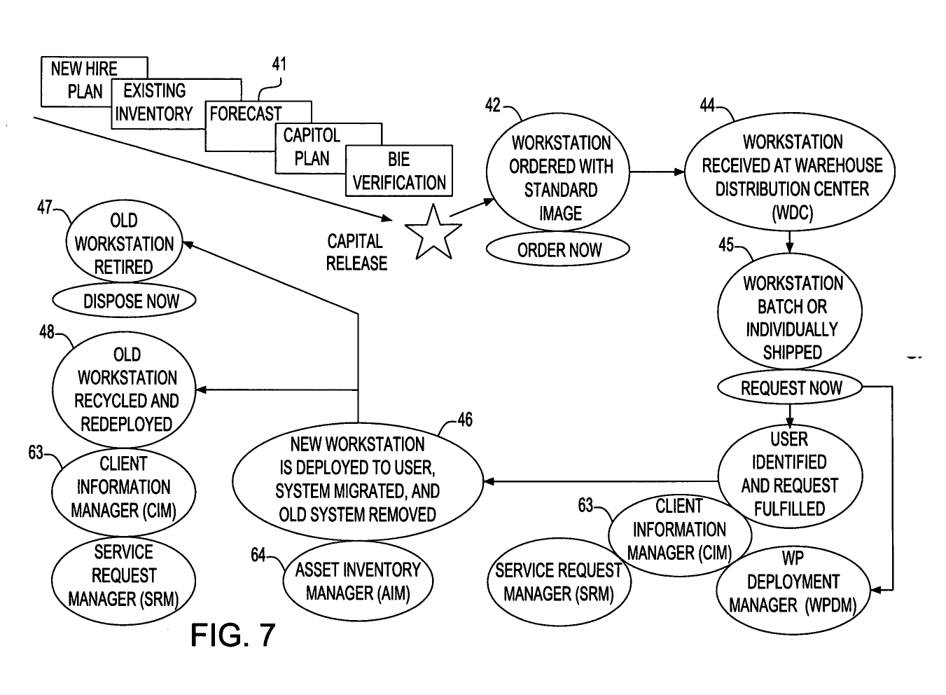

In FIG. 7 there is shown further detail on which process steps of the present invention are handled by the applications shown in FIG. 6. For example, workstation planning and deployment manager application 62 is used to provide the shipping of workstation step 45. CIM 63 is used for both fulfillment and redeployment 48 activities. AIM 64 is used in the deployment and old system removal step 46.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having g an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of allocating resources in an enterprise, comprising the steps of:
identifying a number of areas of the enterprise that need resources;
determining an initial allocation of resources to each of said areas;
establishing an algorithm to assign weights to said initial allocations;
using said algorithm to determine weighted allocations of resources for each of said areas;
keeping said weighted allocations for a given time period; and
as resources become available during said defined time period, assigning said available resources to said areas based on said weighted allocations.

2. A method according to claim 1, wherein the weighted allocations are variable, and comprising the further step of modifying the weighted allocations during said time period.

3. A method according to claim 1, wherein the step of assigning the available resources includes the step of assigning a proportional amount of the available resources to each of said areas based on said weighted allocations.

4. A method according to claim 1, wherein the step of using the algorithm includes the step of programming a processing device to calculate said weighted allocations using said algorithm.

5. A method according to claim 4, wherein the assigning step includes the steps of:
using said processing device to calculate an initial amount of the available resources for each of said areas;
manually changing said initially calculated amount.

6. Apparatus for allocating resources in an enterprise, comprising:
means for identifying a number of areas of the enterprise that need resources;
means for determining an initial allocation of resources to each of said areas;
means for establishing an algorithm to assign weights to said initial allocations;
means for using said algorithm to determine weighted allocations of resources for each of said areas;
means for keeping said weighted allocations for a given time period; and
means for assigning available resources to said areas based on said weighted allocations as resources become available during said defined time period.

7. Apparatus according to claim 6, wherein the weighted allocations are variable, and further comprising means for modifying the weighted allocations during said time period.

8. Apparatus according to claim 6, wherein the means for assigning includes means for assigning a proportional amount of the available resources to each of said areas based on said weighted allocations.

9. Apparatus according to claim 6, wherein the means for using the algorithm includes:
a processing device programmed to calculate said weighted allocations using said algorithm; and
input means for receiving input data for said algorithm.

10. Apparatus according to claim 4, wherein the processing device includes:
means to calculate an initial amount of the available resources for each of said areas; and
means for enabling a user to manually change said initially calculated amount.

11. A program storage device readable by machine, tangibly embodying a program of instructions executable by the machine to perform method steps for allocating resources in an enterprise, said method steps comprising:
identifying a number of areas of the enterprise that need resources;
determining an initial allocation of resources to each of said areas;
establishing an algorithm to assign weights to said initial allocations;
using said algorithm to determine weighted allocations of resources for each of said areas;
keeping said weighted allocations for a given time period; and
as resources become available during said defined time period, assigning said available resources to said areas based on said weighted allocations.

12. A program storage device according to claim 11, wherein the weighted allocations are variable, and comprising the further step of modifying the weighted allocations during said time period.

13. A program storage device according to claim 11, wherein the step of assigning the available resources includes the step of assigning a proportional amount of the available resources to each of said areas based on said weighted allocations.

14. A program storage device according to claim 11, wherein the step of using the algorithm includes the step of programming a processing device to calculate said weighted allocations using said algorithm.

15. A program storage device according to claim 14, wherein the assigning step includes the steps of:
using said processing device to calculate an initial amount of the available resources for each of said areas; and
enabling a user to manually changing said initially calculated amount.

16. A method of deploying a computer program product for allocating resources in an enterprise, wherein when executed, the computer program performs the steps of:
identifying a number of areas of the enterprise that need resources;
determining an initial allocation of resources to each of said areas;
establishing an algorithm to assign weights to said initial allocations;
using said algorithm to determine weighted allocations of resources for each of said areas;
keeping said weighted allocations for a given time period; and
as resources become available during said defined time period, assigning said available resources to said areas based on said weighted allocations.

17. A method according to claim 16, wherein:
the step of assigning the available resources includes the step of assigning a proportional amount of the available resources to each of said areas based on said weighted allocations; and
the weighted allocations are variable, and comprising the further step of modifying the weighted allocations during said time period.

18. A method according to claim 16, wherein:
the step of using the algorithm includes the step of programming a processing device to calculate said weighted allocations using said algorithm; and
the assigning step includes the steps of
i) using said processing device to calculate an initial amount of the available resources for each of said areas, and
ii) enabling a user to manually changing said initially calculated amount.
